(19) United States
(12) Patent Application Publication
(10) Pub. No.: US 2011/0166714 A1
(43) Pub. Date: Jul. 7, 2011

(54) SYSTEMS AND METHODS FOR MONITORING AND CONTROLLING WATER FLOW OF PREMISES

(76) Inventor: Michael S. Stachnik, Telluride, CO (US)

(21) Appl. No.: 12/984,490

(22) Filed: Jan. 4, 2011

Related U.S. Application Data
(60) Provisional application No. 61/292,080, filed on Jan. 4, 2010.

(51) Int. Cl. G05D 7/06; A62C 37/00; A62C 35/60; A62C 3/00

(52) U.S. Cl. 700/282; 169/23; 169/16; 169/47

(57) ABSTRACT

A water flow control system ensures that water does not undesirably flow through water lines of the premises when the premises is unoccupied or when water usage is not desired (e.g., during sleeping hours). The water flow control system is generally operable with an alarm system to control water flow through the water lines of the premises. For example, the alarm system may include a user interface operable to receive input that establishes a state of occupancy for the premises and arms the alarm system. A sensor may detect occupancy of the premises regardless of the established state of occupancy. The water flow control system communicates with the sensors of to determine the actual occupancy within the premises and restrict the water flow to the premises when it is not desired.

### CROSS REFERENCE TO RELATED APPLICATIONS

This patent application claims priority to and thus receives the benefit of an earlier filing date from U.S. Provisional Patent Application No. 61/292,080 (filed Jan. 4, 2010), the entire contents of which are hereby incorporated by reference.

### FIELD OF THE INVENTION

The invention relates to controlling water flow to premises to prevent water damage thereto.

### BACKGROUND

Alarm systems are designed to alert a user to a specific danger. The alarm systems typically include sensors that are coupled to a control unit to provide an alert of the sensed situation. For example, sensors are commonly used to indicate the opening of a door/window, detect motion via passive infrared, detect the presence of smoke, detect the presence of carbon monoxide, and/or detect the presence of water. These sensors may communicate with the control unit of the alarm system to serve a variety of purposes, such as fire protection, intrusion protection, water protection, etc.

Depending on the application, the alarm output may be local or remote. Local alarms are not remotely monitored, though they may include indoor and/or outdoor “sounders”, such as an electronic siren, and lights useful for signaling. However, in certain instances, such as rural areas where the lights or sounds may go unnoticed, local alarms may be useless because no one is alerted to the alarm situation. Alarm systems that provide remote monitoring are capable of dispatching an appropriate response. For example, a smoke detector may trigger an alarm system to generate an alarm signal that is transmitted to a remote monitoring center (e.g., via a phone line) such that fire response services may be dispatched.

Certain alarm system can also be programmed to indicate which sensors were triggered. Monitors may then show the general physical location (or “zone”) of the sensor on a map of the premises to make a response more effective. For example, a water flow alarm of a sprinkler system coupled with a smoke detector in the same area is a more reliable indication of an actual fire in that area than either sensor indication by itself.

### SUMMARY

Systems and methods presented herein provide for controlling water flow in water lines of premises. More specifically, a water flow control system ensures that water does not undesirably flow through water lines of the premises when the premises is unoccupied or when water usage is not desired (e.g., during sleeping hours). The water flow control system is generally operable with an alarm system to control water flow through the water lines of the premises. For example, the alarm system may include a user interface operable to receive input that establishes a state of occupancy for the premises and arms the alarm system. A sensor, such as a motion detector, of the alarm system may be operable to detect occupancy of the premises regardless of the established state of occupancy. In this regard, the water flow control system may be operable to communicate with the sensors of the alarm system to determine the actual occupancy within the premises to control the flow of water. Such has the advantage preventing damage to the premises when the water flow during an unoccupied state of occupancy is due to a burst water line or water leak condition.

In one embodiment, the water flow control system includes a controllable valve coupled to the water line and operable to control the water flow through the water line. The water flow control system also includes a flow meter operable to detect a rate of the water flow and/or an amount of the water through the water line (collectively referred to as the water flow). The water flow control system also includes a processor operable to communicate with the sensor to determine the occupancy of the premises based on the established state of occupancy and communication with the sensor. The processor is also operable to communicate with the flow meter to determine that the water flow through the water line exceeds a threshold level based on the determined occupancy and to generate a control signal. The control signal is operable to close the controllable valve and stop the water flow through the water line in response to determining that the water flow exceeds the threshold.

The processor may be further operable to generate an alarm message operable to initiate dispatch of a service provider. For example, the processor may transfer the alarm message to the alarm system which, in turn, transfers the message to a remote monitoring service. The remote monitoring service, depending on the situation, may alert a particular service provider to the alarm message (e.g., a home owner, a plumber, lawn care service provider, pool maintenance provider, etc.). The processor may also be operable to determine that the water flow is associated with a selected water usage during an unoccupied state of occupancy. For example, the processor may determine that water flow to unoccupied premises may be due to a timed lawn care system. Accordingly, the processor may allow the water to flow within the water line of the premises.

The water flow control system may also include a water sensor operable to detect a water leak within the premises. In this regard, the processor may be operable to communicate with the water leak sensor and generate a message for presentation via the user interface of the alarm system to inform an occupant of the premises of the water leak. For example, the water flow control system may be configured with a plurality of flow meters operable to detect water flow through multiple water lines within the premises. Accordingly, if the water leak detector senses water within a certain location while water flow through a particular water line is being monitored by a flow meter, a likely location of the water leak may be deduced and presented to an occupant of the premises via the user interface of the alarm system. Alternatively or additionally, this information may be presented to the remote monitoring center or service provider dispatch.

The water flow control system may also be operable with a smoke detector of the alarm system. In this regard, the processor is further operable to communicate with the smoke detector to determine that the water flow exceeding the threshold through the water line is associated with fire prevention. Accordingly, the water flow control system will maintain the water flow through the water line without regard to the occupancy. The water flow control system may also include a bypass switch that is operable to allow the water flow through the water line to breach the threshold level during an unoccupied state of occupancy. For example, certain service providers, such as gardeners and pool maintenance personnel, may require water usage without requiring access to the interior of the premises. Accordingly, the service providers may be allowed to disengage via the bypass switch the water flow control system such that water is not restricted.

The various embodiments disclosed herein may be implemented in a variety of ways as a matter of design choice. The embodiments may take the form of hardware, software, firmware, or combinations thereof. For example, the water flow control system and/or the components thereof may be configured as a software module within the alarm system or as an entirely separate device to operate in the manner described above. In another embodiment, a computer readable medium is operable to store software instructions for controlling the water flow. These software instructions are configured so as to direct the processor to operate in the manner described above.

### BRIEF DESCRIPTION OF THE DRAWINGS

FIG. 1 is a block diagram of an exemplary water flow control system operable with an alarm system.

FIG. 2 is a block diagram of the exemplary water flow control system.

FIG. 3 is a flow chart illustrating an exemplary process of controlling water flow through a water line of premises.

FIG. 4 illustrates an exemplary computer system operable to execute computer readable medium embodying programmed instructions to perform desired functions.

### DETAILED DESCRIPTION OF THE DRAWINGS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

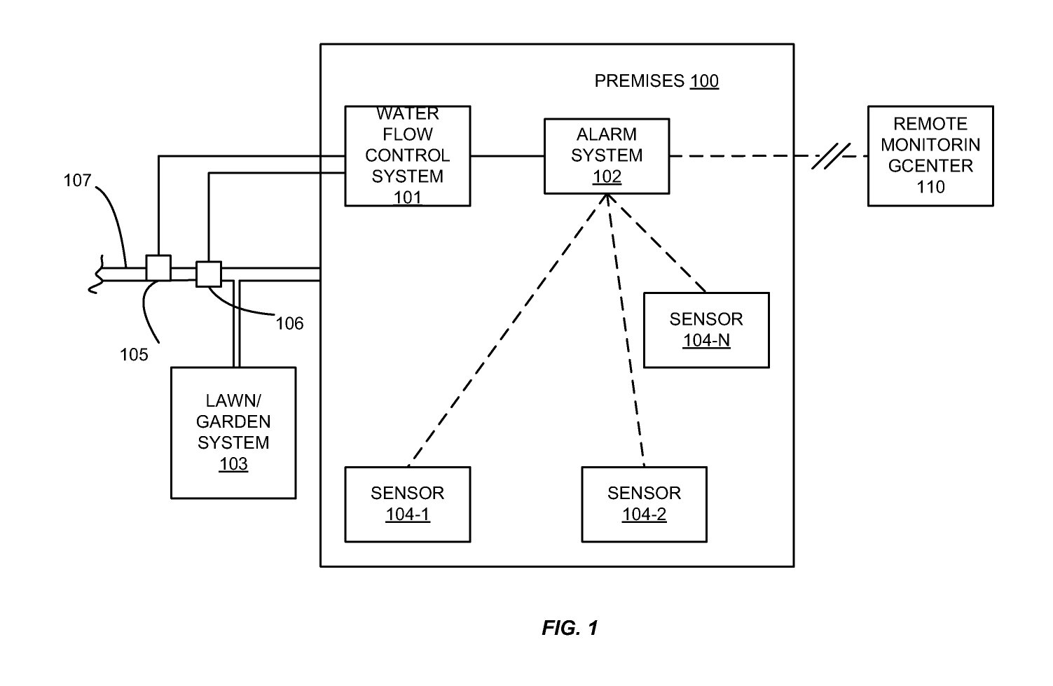

FIG. 1 is a block diagram of an exemplary water flow control system 101 operable with an alarm system 102 on premises 100 (e.g., a residence, office building, warehouse, etc.). The water flow control system 101 is operable to stop or slow the flow of water through a water line 107 of the premises 100 based on a determination of the occupancy of the premises 100. For example, the alarm system 102 of the premises 100 may be configured with a plurality of sensors 104-1-N that are operable to detect, among other things, the occupancy of the premises 100 (where “N” is an integer greater than 1). Thus, when an occupant of the premises 100 arms the alarm system 102 by establishing the state of occupancy as unoccupied, the sensors 104 may determine when the perimeter of the premises 100 is breached. In this regard, the alarm system 102 may trigger a visible alert (e.g., lighting), an audible alert, and/or a message transmission to the remote monitoring center 110 such an appropriate responder may be dispatched. However, when the occupant of the premises 100 neglects to establish the state of occupancy (e.g., while walking out the door), the alarm system 102 is not armed. The water flow control system 101 may therefore be incapable of determining that the premises 100 are unoccupied. Thus, the water flow control system 101 is configured to determine this unoccupied state of the premises 102 while monitoring the water flow through the water line 107 via the flow meter 106 so as to prevent water damage to the premises 100 (e.g., via leaks, burst pipes, etc.) and/or excess water usage. In doing so, the water flow control system 101 may transmit a control signal to a controllable water valve 105 to close the water valve 105 or a least slow the water flow through the water line 107.

The water flow control system 101 is any system capable of communicating with an alarm system 102, the flow meter 106, and the controllable valve 105. For example, the water flow control system 101 may be implemented as a processor module separate from the alarm system 102 operable to interface with the various devices. Alternatively, the water flow control system 101 may be implemented as a module within the alarm system 102 via hardware, software, firmware, or a combination thereof to communicate with the flow meter 106 and the controllable valve 105.

The alarm system 102 is any system capable of communicating with the sensors 104 to establish a state of occupancy for the premises and alert the remote monitoring center 110 as to any intrusions or other response situations. For example, the sensors 104 may include infrared motion detectors, door sensors, and/or window sensors that are operable to detect intrusions into the premises 100 once a user establishes a particular state of occupancy for the premises 100. In this regard, the alarm system 102 may alert the remote monitoring center 110 as to an undesirable intrusion when armed. Certain sensors 104 may also detect other situations. For example, some of the sensors 104 may be operable to detect water leaks, smoke, carbon monoxide, etc. In this regard, the alarm system 102 may alert the remote monitoring system 110 as to the particular response situation. For example, a smoke detector may be used to alert the remote monitoring center 110 to the possibility of a fire such that fire prevention services may be dispatched to the premises 100.

The water line 107 in this embodiment is a main water line to the premises 100 that supplies water to the various water outlets within the premises 100 (e.g., faucets, lawn/garden care system 103, water dispensers, etc.). However, the water flow control system 101 is not intended to be limited to simply main water lines. For example, the flow meter 106 and controllable valve 105 may be configured with other water lines within the premises 100 to more discretely control the water flow within the premises 100. The controllable valve 105 may be implemented in a variety of ways subject to a matter design choice. For example, the controllable valve 105 may be operable to receive a control signal from the water flow control system 101 in various forms, including optically, electronically, or via radio frequency to alter the water flow through the water line 107. The various configurations of the controllable valve 105 and the flow meter 106 are known to those skilled in the art.

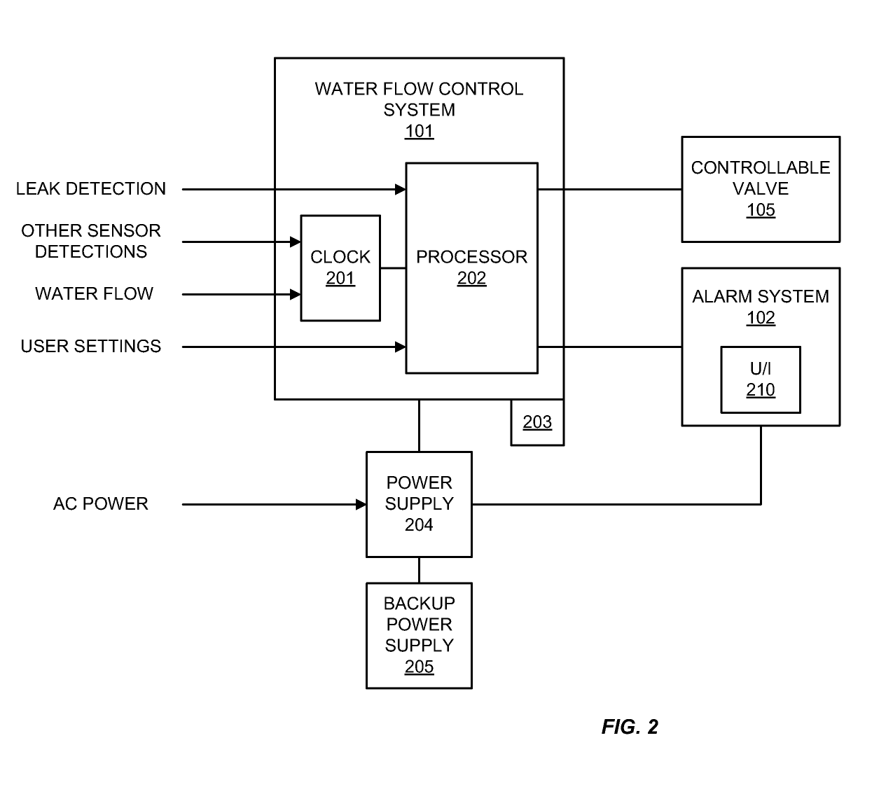

FIG. 2 is a block diagram of the exemplary water flow control system 101. In this embodiment, the water flow control system 101 is configured with a processor 202 and a clock 201. The processor 202 is any device and/or software operable to logically control the controllable valve 105 based on various inputs to the processor 202. For example, the processor 202 may determine occupancy of the premises 101 based on user settings input through the user interface 210 of the alarm system 102. The processor 202 may also determine leaks based on information supplied by water sensors within the premises 101. For example, one or more of the sensors 104 of the premises 101 may detect liquids on floors. This information may be provided to the processor 202 via the alarm system 102 and/or directly from the water sensor such that the processor 202 may identify a general location of the leak within the premises 101 to shut off the controllable valve 105 of the water line of that leak. Alternatively or additionally, the water flow control system 101 may also be operable to generate a message for presentation of the location of the leak via the user interface 210 of the alarm system 102. The clock 201 is any device and/or software operable to establish a duration (e.g., a “timer”) for controlling the water flow. For example, if the water flow through the water line 107 of the premises 100 breaches a predetermined threshold level when the premises 100 is unoccupied, the clock 201 may establish a duration for which the water shall continue to flow through the water line 107 as such water flow may be for a useful purpose (e.g., lawn/garden system 103, pool/hot tub water leveling systems, etc.). If the water flow continues above the threshold level after that duration, the processor 202 may shut off the water flow via the controllable valve 105.

An example of such may occur when the lawn/garden system 103 initiates its watering sequence. At first, the water flow through the lawn/garden system 103 may increase dramatically as water initially fills the water lines of the lawn/garden system 103 without resistance. Once filled, however, the water flow may be directly related to the resistance of the water through various sprinkler heads and drip modules. Accordingly, a relatively short duration may be set in such as way as to establish a period in which the initial water flow shall be allowed to breach the threshold level. If the water flow continues to breach that threshold level after the duration has expired, the processor 202 may direct the controllable valve 105 to shut off the water to the lawn/garden system 103, as such increased water flow may be related to a leak, a broken sprinkler head, or the like. In such a case, the processor 202 may be further operable to generate a message that initiates a response by the remote monitoring center 110. For example, the remote monitoring center 110 may receive notice from the processor 202 (e.g., via the alarm system 102) that the lawn/garden system 103 is in need of repair. The remote monitoring center 110 may then initiate dispatch of such services upon the occupant's request. Alternatively or additionally, the processor 202 may simply indicate such via the user interface 210 of the alarm system 102.

In one embodiment, the water flow control system 101 is also configured with a bypass switch 203 that is operable to disengage the water flow control system 101 from restricting the water flow to the premises 100. For example, although the interior of the premises 101 may be deemed unoccupied, certain service providers such as gardeners may require water usage while not requiring interior access to the premises 100. Accordingly, the bypass switch 203 may allow the service providers to disengage the water flow control system 101 such that they may use the water to the premises 100 freely.

In another embodiment, the water flow control system 101 is powered by a power supply 204. For example, the water flow control system 101 (as well as the alarm system 102) may include DC powered electronics. The power supply 204 may receive AC power of the premises 100 and convert that power to DC such that the water flow control system 101 may logically control the functionality of the water flow. As with many electronic alarm systems, the power supply 204 may be backed up with a backup power supply 205, such as a battery. For example, when the AC power to the premises 100 fails, the backup power supply 205 supplies power to the water flow control system 101 (and the alarm system 102) until the AC power is restored. In one embodiment, the water flow control system 101 is operable to prevent water flow through the water line 107 when the power fails. For example, as a failsafe position, the water flow control system 101 may detect a power failure (i.e., in the AC power supply or from the power supply 204) and switch to the backup power supply 205. In this case, the water flow control system 101 may automatically close the controllable valve 106 such that water does not flow through the water line 107. As the backup power supply 205 will only operate for a limited amount of time until the AC power is restored, this failsafe position of the water flow control system 101 prevents water damage to the premises 100 during the power outage.

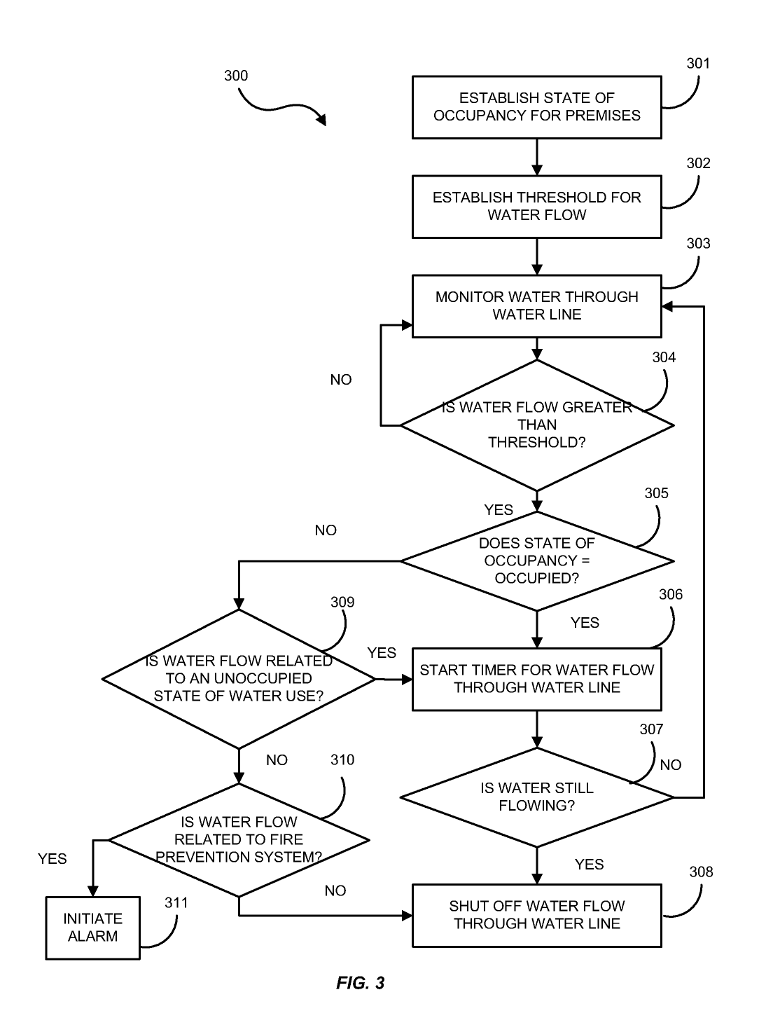

This failsafe position of the water flow control system 101 may also be established based upon some time that the backup power supply is expected to be active. For example, the backup power supply 205 may be configured to operate for some predetermined amount of time based on a certain power consumption by the water flow control system 100 and/or the alarm system 102. In this regard, the water flow control system 101 may use the clock 201 to establish a timer that allows the controllable valve 106 to be open until the timer expires. After that time, the water flow control system 101 closes the controllable valve 106 to shut off the water flow through the water line 107. Alternatively, the water flow control system 101 may simply close the controllable valve 106 when power from the backup power supply 205 is exhausted (i.e., the power keeps the controllable valve 106 open). It should be readily recognized, however, that this failsafe feature may be overridden with the bypass switch 203 in case the premises 100 is occupied and water flow is desired (e.g., by the occupants thereof). Additional details of the water flow control system 101 are now described with respect to a process for controlling the water flow in FIG. 3.

FIG. 3 is a flow chart illustrating an exemplary process 300 of controlling water flow through a water line of the premises 100. In this embodiment, the process 300 initiates with the establishment of a state of occupancy for the premises 100, in the process element 301. For example, a user may arm the alarm system 102 through the user interface 210 when leaving the premises 100, thereby indicating that the premises 100 is no longer occupied. Thus, the sensors 104-1-N may be set to detect any intrusion within the premises 100 (e.g., via a door opening, a window break, and motion detection, etc.). In some instances, however, an occupant of the premises 100 may neglect to arm the alarm system 102 and thus fail to establish the state of occupancy as unoccupied. Certain sensors 104 of the alarm system 102 (e.g., motion detectors) remain operable to detect movement within the premises 100. In this regard, the water flow control system 101 may be operable to determine the actual occupancy using the sensors so as to control the water flow.

The water flow control system 101 may also establish a threshold for the water flow, in the process element 302. More specifically, when the premises 100 are unoccupied, the water flow control system 101 may establish water flow rates for various conditions and/or times. For example, although the premises 100 are unoccupied, the lawn/garden system 103 may still require water flow to maintain vegetation on the premises 100. Accordingly, the water flow control system 101 may establish a higher threshold of water flow for a particular time and duration when the lawn/garden system 103 initiates. Alternatively, if the premises 100 are occupied, the water flow control system 101 may allow the water to flow uninhibited to the premises 100. However, the invention is not intended to be limited to any particular threshold of water flow as such may be determined as a matter of user desire and/or design choice. Moreover, the water flow control system 101 may establish multiple threshold levels of water flow depending on certain user settings. For example, an occupant may wish to restrict the level of water flow within the premises 100 at a time of the day when no one is expected to use water (e.g., during sleeping hours).

In any case, once the threshold(s) for the water flow has been established, the water flow control system 101 monitors the water flow through the water line 107, in the process element 303. In doing so, the water flow control system 101 may communicate with the flow meter 106 to determine whether the rate or the amount of the water flow is greater than the threshold, in the process element 304. If not, the water flow control system 101 continues to monitor the water flow through the water line 107. Otherwise, the water flow control system 101 makes a determination as to the actual state of occupancy of the premises 100, in the process element 305. For example, if the alarm system 102 is set to an unoccupied state (e.g., the alarm is armed), the water flow control system 101 may determine that the premises 100 is indeed unoccupied. Alternatively, when the user neglects to establish a state of occupancy, the water flow control system 101 may communicate with the alarm system 102 to make a determination as to whether any of the sensors 104-1-N has been “tripped” within a certain period of time so as to determine whether the premises 100 is occupied. For example, although the alarm system 102 is not set to an unoccupied state by a user, the premises 100 may indeed be unoccupied. In this regard, the water flow control system 101 may communicate with the alarm system 102 to determine whether the sensors 104-1-N have detected any intrusions to the premises 100 that would indicate that the premises 100 is occupied (e.g., motion detectors being tripped and thereby indicating that someone is within the premises 100).

If the water flow control system 101 determines that the premises 100 is occupied, the water flow control system 101 may start a timer via the clock 201 that establishes a period of time for which water may continue to flow through the water line 107, in the process element 306. After the timer expires, the water flow control system 101 may determine whether the water is still flowing (e.g., at a rate or amount above the threshold level), in the process element 307. If not, the water flow control system 101 may return to the process element 303 to continue monitoring the water flow through the water line 107. If the water continues to flow through the water line 107, the water flow control system 101 may generate a control signal is operable to direct the controllable valve 105 to shut off the water flow through the water line 107, in the process element 308.

If the water flow control system 101 determines that the premises 100 is unoccupied (i.e., via the process element 305), the water flow control system 101 may determine that the water flow is related to an unoccupied state of water use, in the process element 309. For example, the water flow control system 101 may determine that the lawn/garden system 103 has initiated based on some user/time setting of the lawn/garden system 103. In this regard, the water flow control system 101 may direct the clock 201 to initiate a timer that coincides with the user/time setting of the lawn/garden system 103, in the process element 306, to ensure that the water flow of the lawn/garden system 103 is not inhibited while ensuring that the water flow stops or reduces when desired. Although this example illustrates one unoccupied state of water use in the lawn/garden system 103, the invention is not intended to be so limited as other water usages may be provided when the premises 100 is deemed unoccupied. For example, swimming pools, ponds, hot tubs, and the like are often equipped with water levelers that automatically provide water when the water is deemed to be below a desired level. Accordingly, the water flow control system 101 may be configured to adapt to such water usages. One manner may include allowing the water to flow through the water line 107 at a certain threshold level (e.g., via a partial opening of the water valve 105) for a desired duration on a periodic basis.

If the water flow control system 101 determines that the water flow is not related to the unoccupied state of water use, the water flow control system 101 may determine that the water flow is related to a fire prevention system, in the process element 310. For example, one or more of the sensors 104-1-N may be a smoke detector that indicates to the alarm system 102 that a fire is occurring within the premises 100. As many buildings and homes are now configured with fire extinguishing systems (e.g., water sprinklers), water flow through the water line 107 may increase dramatically so as to extinguish the fire. In such a case, the water flow control system 101 would not shut off the water flow to the premises as such would be undesirable. Instead, the water flow control system 101 may communicate with the alarm system 102 to initiate an alarm, in the process element 311. For example, the premises 100 may be configured with a plurality of flow meters 106, one or more of which being operable to monitor the water flow through the fire extinguishing system. The water flow control system 101 may detect this water flow and provide the location of the flow meter(s) 106 to the alarm system 102. The alarm system 102 may, in turn, generate an alarm message based on the location of the sensor(s) 104 detecting the fire, thereby indicating the specific location of the fire within the premises 100. The alarm system 102 may transfer this information to the remote monitoring system 110 such that firefighting personnel may be dispatched and alerted to the likely location of the fire. If, however, the water flow is not related to the fire prevention system, the water flow control system 101 shuts off the water flow, in the process element 308.

In one embodiment, the water flow control system 101 may also be operable to control the water flow based on seasonal changes. For example, the water flow control system 101 may have summer and winter modes so as to provide for irrigation during summer months when water line bursts due to freezing are less likely. In this mode, the water flow control system 101 may monitor the water flow through to the premises 100 as well as the lawn/garden care system 103. In doing so, the water flow control system 101 may establish an unoccupied timer with the clock 201 to allow for the irrigation (e.g., 15 minutes for each zone) so as to ensure irrigation is provided for at least 7 -10 minutes per zone (e.g., including a 2 minute delay such that the water flow may settle down and reset the clock 201). In the winter mode when no irrigation is required, the unoccupied timer of the clock 201 may be established at a minimum (e.g., one minute or less) so as to prevent water flow from a leak being mistaken as summer irrigation. Such a summer/winter mode setting may be preconfigured with the water flow control system 101 such that it does not require reprogramming upon seasonal changes.

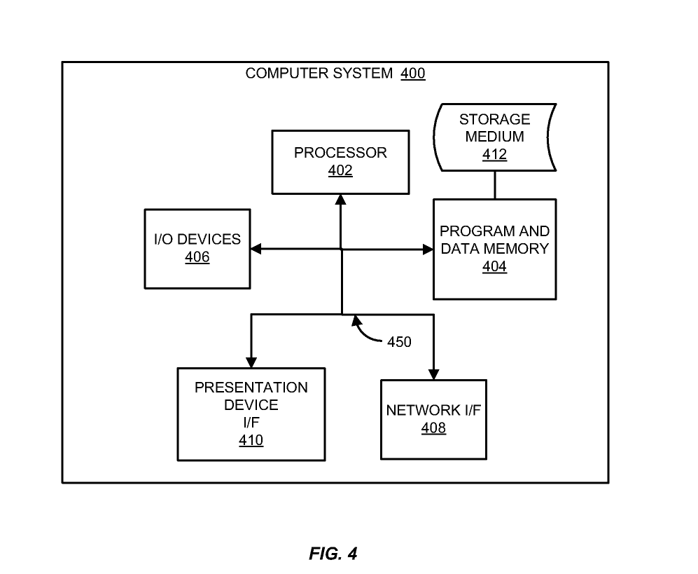

As mentioned, embodiments disclosed herein can take the form of software, hardware, firmware, or various combinations thereof. FIG. 4 is a block diagram depicting a computer system 400 also operable to provide the above features by executing programmed instructions and accessing data stored on a computer readable storage medium 412. In this regard, embodiments of the invention can take the form of a computer program accessible via the computer readable storage medium 412 providing program code for use by a computer or any other instruction execution system. For the purposes of this description, a computer readable storage medium 412 can be anything that can contain, store, communicate, or transport the program for use by the computer or other instruction execution system.

The computer readable storage medium 412 can be an electronic, magnetic, optical, electromagnetic, infrared, or semiconductor device. Examples of the computer readable medium 412 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

The computer system 400, being suitable for storing and/or executing the program code, includes at least one processor 402 coupled to memory elements 404 through a system bus 450. The memory elements 404 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 406 (including but not limited to keyboards, displays, pointing devices, etc) can be coupled to the system either directly or through intervening I/O controllers. Network adapter interfaces 408 may also be coupled to the system to enable the computer system 400 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 410 may be coupled to the system to interface to one or more presentation devices, such as printing systems and displays for presentation of presentation data generated by processor 402.

Although shown and described with respect to the process elements being performed in a particular order, those skilled in the art should readily recognize that the process elements may be performed in other manners. For example, determining the occupancy of the premises 100 may be performed continually throughout the process 300 and not simply after the detection of a water flow threshold breach. Additionally, components of the water flow control system 101 may be configured and/or arranged in other ways while still providing the water control features described above. Accordingly, while specific embodiments are described herein, the scope of the invention is not limited to those specific embodiments.

We claim:

1. A water flow control system operable with an alarm system to control water flow through a water line of a premises, the alarm system comprising a user interface operable to receive input that establishes a state of occupancy for the premises and arm the alarm system, and a sensor operable to detect occupancy of the premises, the water flow control system including:
a controllable valve coupled to the water line and operable to control the water flow through the water line;
a flow meter operable to detect the water flow through the water line; and
a processor operable to communicate with the sensor to determine the occupancy of the premises based on the established state of occupancy and communication with the sensor, to communicate with the flow meter to determine that the water flow through the water line exceeds a threshold level based on the determined occupancy, and to generate a control signal operable to close the controllable valve and stop the water flow through the water line in response to determining that the water flow exceeds the threshold.

2. The water flow control system of claim 1, wherein the processor is further operable to generate an alarm message operable to initiate dispatch of a service provider.

3. The water flow control system of claim 1, wherein the processor is further operable to determine that the water flow is associated with a selected water usage during an unoccupied state of occupancy.

4. The water flow control system of claim 1, wherein the sensor is at least one of a motion detector and an intrusion sensor.

5. The water flow control system of claim 1, further including a water sensor operable to detect a water leak within the premises.

6. The water flow control system of claim 5, wherein the processor is further operable to communicate with the water leak sensor and to generate a message for presentation via the user interface to inform an occupant of the premises of the water leak.

7. The water flow control system of claim 1, wherein the processor is further operable to communicate with a smoke detector to determine that the water flow exceeding the threshold through the water line is associated with fire prevention and to maintain the water flow through the water line without regard to the occupancy.

8. The water flow control system of claim 1, further including a bypass switch operable to allow the water flow through the water line to breach the threshold level during an unoccupied state of occupancy and enable water usage for a service provider.

9. The water flow control system of claim 1, further including a power supply, wherein the processor is further operable to direct the controllable valve to stop the water flow through the water line when the power supply fails.

10. A method of controlling water flow through a water line of premises, including:
establishing a state of occupancy;
monitoring occupancy of the premises with one or more sensors;
establishing a threshold level for the water flow through the water line based on the state of occupancy;
monitoring the water flow through the water line;
detecting a water flow breach of the threshold level;
determining the occupancy of the premises as unoccupied based on the established state of occupancy and the monitored occupancy of the premises; and
stopping the water flow through the water line based on the determined occupancy of the premises.

11. The method of claim 10, further including generating an alarm message operable to initiate dispatch of a service provider.

12. The method of claim 10, further including determining that the water flow is associated with a selected water usage during an unoccupied state of occupancy.

13. The method of claim 10, wherein the one or more sensors are motion detectors.

14. The method of claim 10, further including detecting a water leak within the premises.

15. The method of claim 14, further including:
communicating with the water leak sensor; and
generating a message for presentation via the user interface to inform an occupant of the premises of the water leak.

16. The method of claim 10, further including:
detecting a fire with a smoke detector;
communicating with the smoke detector to determine that the water flow exceeding the threshold through the water line is associated with fire prevention;
maintaining the water flow through the water line without regard to the occupancy.

17. The method of claim 10, further including bypassing the method of controlling the water flow to allow the water flow through the water line to breach the threshold level during an unoccupied state of occupancy to enable water usage for a service provider.

18. The method of claim 10, further including stopping the water flow through the water line during a power outage.

19. A computer readable medium including software instructions that, when executed on a processor, are operable to direct the processor to control water flow through a water line of a premises, the software instructions being further operable to direct the processor to:
establish a state of occupancy;
monitor occupancy of the premises with one or more sensors;
establish a threshold level for the water flow through the water line based on the state of occupancy;
monitor the water flow through the water line;
detect a water flow breach of the threshold level;
determine the occupancy of the premises as unoccupied based on the established state of occupancy and the monitored occupancy of the premises; and
stop the water flow through the water line based on the determined occupancy of the premises.

20. The computer readable medium of claim 19, further comprising instructions that direct the processor to:
generate an alarm message operable to initiate dispatch of a service provider.

21. The computer readable medium of claim 19, further comprising instructions that direct the processor to:
determine that the water flow is associated with a selected water usage during an unoccupied state of occupancy.

22. The computer readable medium of claim 19, further comprising instructions that direct the processor to:
detect a water leak within the premises;
communicate with the water leak sensor; and
generate a message for presentation via the user interface to inform an occupant of the premises of the water leak.

23. The computer readable medium of claim 19, further comprising instructions that direct the processor to:
detect a fire with a smoke detector;
communicate with the smoke detector to determine that the water flow exceeding the threshold through the water line is associated with fire prevention;
maintain the water flow through the water line without regard to the occupancy.

24. The computer readable medium of claim 19, further comprising instructions that direct the processor to:
bypass control of the water flow to allow the water flow through the water line to breach the threshold level during an unoccupied state of occupancy to enable water usage for a service provider.

25. The computer readable medium of claim 19, further including stopping the water flow through the water line during a power outage.
